(19) United States
(12) Patent Application Publication
(10) Pub. No.: US 2015/0269734 A1
(43) Pub. Date: Sep. 24, 2015

(54) APPARATUS AND METHOD FOR RECOGNIZING LOCATION OF OBJECT

(71) Applicant: ELECTRONICS AND TELECOMMUNICATIONS RESEARCH INSTITUTE, Daejeon (KR)

(72) Inventors: Jae-Yeong LEE, Daejeon (KR); Myung-Chan ROH, Daejeon (KR)

(21) Appl. No.: 14/663,938

(22) Filed: Mar. 20, 2015

(30) Foreign Application Priority Data
Mar. 20, 2014 (KR) 10-2014-0032606

(51) Int. Cl. G06T 7/00; G06K 9/48; G06K 9/00

(52) U.S. Cl. CPC G06T 7/0044; G06K 9/00624; G06K 9/48; G06K 9/00798; G06T 2207/30244

(57) ABSTRACT

Disclosed herein is an apparatus and method for recognizing the location of an object, which recognize the location of an object using an artificial landmark that is easily identifiable in an outdoor environment and that minimizes visual resistance. The presented apparatus includes an image acquisition unit for acquiring an image of an artificial landmark implemented using at least one of a first-type mark and a second-type mark, an artificial landmark detection unit for processing the image acquired by the image acquisition unit and detecting the artificial landmark from the image, a pose calculation unit for calculating a pose of the object based on an image coordinate and a world coordinate of the artificial landmark detected by the artificial landmark detection unit, and a pose verification unit for verifying whether the pose of the object calculated by the pose calculation unit are within an effective range.

### CROSS REFERENCE TO RELATED APPLICATION

This application claims the benefit of Korean Patent Application No. 10-2014-0032606 filed Mar. 20, 2014, which is hereby incorporated by reference in its entirety into this application.

### BACKGROUND OF THE INVENTION

1. Technical Field

The present invention generally relates to an apparatus and method for recognizing the location of an object and, more particularly, to an apparatus and method that recognize the location of an object, such as a camera, an unmanned vehicle or a mobile robot, using an artificial landmark.

2. Description of the Related Art

In order for an object, such as an unmanned vehicle or an indoor/outdoor mobile robot, to autonomously drive, the precise determination of the object's own location is the most important factor.

Methods of determining the location of an object include a method using a position sensor such as a Global Positioning System (GPS) sensor, a method of recognizing a surrounding environment using camera-captured images, etc., but those methods have their own disadvantages.

A typical GPS sensor has very-low location precision (having a location error of about 10 m), and a GPS sensor having high precision is very expensive. However, even in the case of expensive GPS products, the location precision thereof may be greatly deteriorated when many tall buildings are present near the GPS products (GPS shadow area). Further, there is a problem in that a GPS is only applicable to outdoor areas.

Meanwhile, a location recognition method using camera-captured images is a method of matching previously stored image information (that is, image information having a known location) with an input image and determining an object's own location. However, since typical image recognition has serious image variations depending on weather, time zones, lighting, or the like due to the characteristics of images, a problem arises in that a recognition success rate is low and a long time is required to process images.

Therefore, in an actual application, methods of attaching artificial landmarks, manufactured to be easily identified, to floors, ceilings, walls, etc., and then recognizing the artificial landmarks have been mainly used.

As preceding technologies related to the location recognition method using artificial landmarks, there are Korean Patent Application Publication No. 10-2007-0066192 (entitled “Method and Apparatus for Determining Positions of Robot”) and Korean Patent Application Publication No. 10-2011-0066714 (entitled “Apparatus and Method for Recognizing Position of Mobile Robot”).

An invention disclosed in Korean Patent Application Publication No. 10-2007-0066192 proposes a landmark in which circular marks 1 and 2 are arranged in a square patch 5, as shown in FIG. 1.

An invention disclosed in Korean Patent Application Publication No. 10-2011-0066714 proposes a scheme for identifying the IDs of landmarks using a grid pattern in a square patch 7, as shown in FIG. 2.

However, since the conventional artificial landmark methods are mainly developed to be focused on location recognition in an indoor environment, there is the problem of making it difficult to apply those methods to an outdoor environment such as in an unmanned vehicle application. The reason for this is described as follows.

First, there is a problem with appearance. More specially, in an outdoor environment, landmarks are attached to the ground such as a road, but the artificial landmarks presented in Korean Patent Application Publication Nos. 10-2007-0066192 and 10-2011-0066714 do not have a shape that can be generally found on the road surface or the like, and thus they are excessively conspicuous, and are not harmonious with a surrounding environment. Further, since the use of artificial landmarks is easily exposed, it is difficult to apply those methods to the exhibition of advanced technology such as unmanned autonomous driving technology.

Second, an artificial landmark having a simple pattern is more suitable for an outdoor environment than an artificial landmark having a complicated pattern. In an indoor environment, an artificial landmark may be attached to the ceiling or wall surface of a structure, and thus a camera may be arranged to perpendicularly face the artificial landmark. However, in an outdoor environment, a camera obliquely faces the artificial landmark attached to the ground. Accordingly, when a complicated pattern is included in an artificial landmark as in the case of a conventional artificial landmark, a problem arises in that it is difficult to identify the artificial landmark at a long distance. In particular, since the recognition of a landmark is required at a relatively long distance due to the characteristics of an outdoor application, an artificial landmark having a simple shape is more effective.

### SUMMARY OF THE INVENTION

Accordingly, the present invention has been made keeping in mind the above problems occurring in the prior art, and an object of the present invention is to provide an apparatus and method for recognizing the location of an object, which recognize the location of an object using an artificial landmark that is easily identifiable in an outdoor environment and that minimizes visual resistance.

In accordance with an aspect of the present invention to accomplish the above object, there is provided an apparatus for recognizing a location of an object, including an image acquisition unit for acquiring an image; an artificial landmark detection unit for processing the image acquired by the image acquisition unit and detecting an artificial landmark of a predetermined type from the image; a pose calculation unit for calculating a pose of the object based on an image coordinate and a world coordinate of the artificial landmark detected by the artificial landmark detection unit; and a pose verification unit for verifying whether the pose of the object calculated by the pose calculation unit are within an effective range.

The artificial landmark detection unit may binarize the input image acquired by the image acquisition unit, analyze connected components of a binarized image, extract contours of the connected components, approximate the extracted contours of the connected components to polygons, analyze the approximated polygons, and determine whether the connected components correspond to the artificial landmark.

The artificial landmark detection unit may analyze the approximated polygons based on a number of vertexes of the approximated polygons and shapes of the approximated polygons, and then determine whether the connected components correspond to the artificial landmark.

The pose calculation unit may extract information about a geometric relationship between the artificial landmark and the object from an image coordinate and a world coordinate of the artificial landmark detected by the artificial landmark detection unit, and calculate the pose of the object based on the extracted geometric relationship information. The pose may represent a position and an orientation. The pose of the object may include a position of the object and an orientation of the object.

The pose verification unit may ignore values of the pose of the object calculated by the pose calculation unit if it is determined that the calculated pose of the object are not effective values.

The artificial landmark may be installed on a surface of a road.

The predetermined type includes a first-type.

A mark of the first-type may be a mark composed of a pair of bars.

The mark composed of a pair of bars may be installed on a surface of a linear driving road.

The predetermined type includes a second-type.

A mark of the second-type may be a “ [symbol] ”-shaped mark.

The “ [symbol] ”-shaped mark may be installed on a surface of a road at each of a source, a destination, and principal corners.

In accordance with another aspect of the present invention to accomplish the above object, there is provided a method for recognizing a location of an object, including acquiring an image; detecting, by an artificial landmark detection unit, an artificial landmark of a predetermined type from the acquired image by processing the acquired image; calculating, by a pose calculation unit, a pose of the object based on an image coordinate and a world coordinate of the detected artificial landmark; and verifying, by a pose verification unit, whether the calculated pose of the object are within an effective range.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an example of a conventional artificial landmark;

FIG. 2 is a diagram showing another example of a conventional artificial landmark;

FIG. 3 is a diagram showing an example of an artificial landmark employed in an embodiment of the present invention;

FIG. 4 is a diagram showing another example of an artificial landmark employed in an embodiment of the present invention;

FIG. 5 is a diagram showing an example in which an artificial landmark employed in an embodiment of the present invention is attached to the ground of a road;

FIG. 6 is a configuration diagram showing an apparatus for recognizing the location of an object according to an embodiment of the present invention;

FIG. 7 is a flowchart showing a method for recognizing the location of an object according to an embodiment of the present invention;

FIGS. 8 to 11 are diagrams applied to the description of an artificial landmark detection step shown in FIG. 7; and

FIGS. 12 and 13 are diagrams applied to the description of steps S18 and S20 shown in FIG. 7.

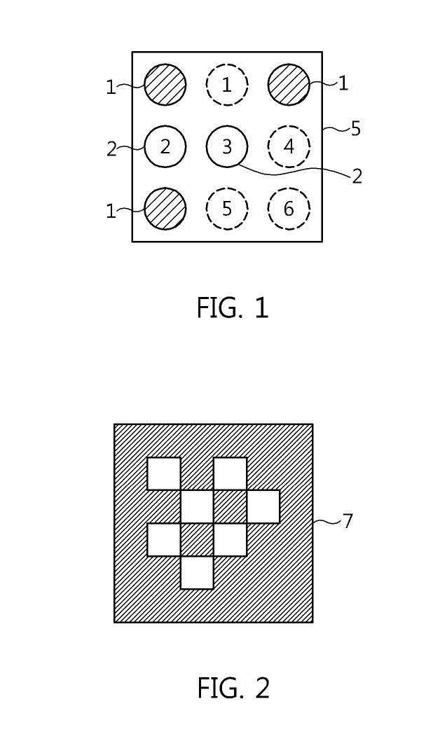

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

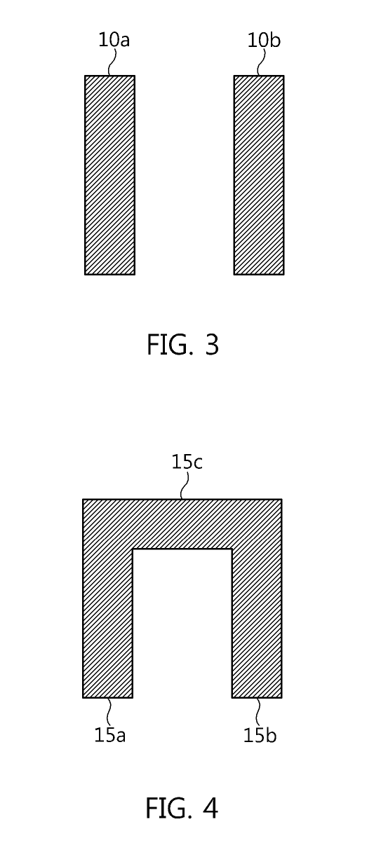

FIG. 3 is a diagram showing an example of an artificial landmark employed in an embodiment of the present invention.

In FIG. 3, an artificial landmark 10 is implemented as a mark composed of a pair of bars 10a and 10b. The bars 10a and 10b are located in parallel with each other while being spaced apart from each other, and may be formed to have the same length and the same thickness (e.g., about 15 cm).

FIG. 4 is a diagram showing another example of an artificial landmark employed in an embodiment of the present invention.

In FIG. 4, an artificial landmark 15 is implemented as a type of mark in which three bars 15a, 15b, and 15c are connected to each other. The bar 15a and the bar 15b are connected to each other through the bar 15c to take a “ [symbol] ” shape. the “ [symbol] ” shape may be a shape of a line with two 90° angles. In other words, the artificial landmark 15 is implemented as a “ [symbol] ”-shaped mark. Here, the bars 15a, 15b, and 15c may be formed to have the same thickness (e.g., 15 cm).

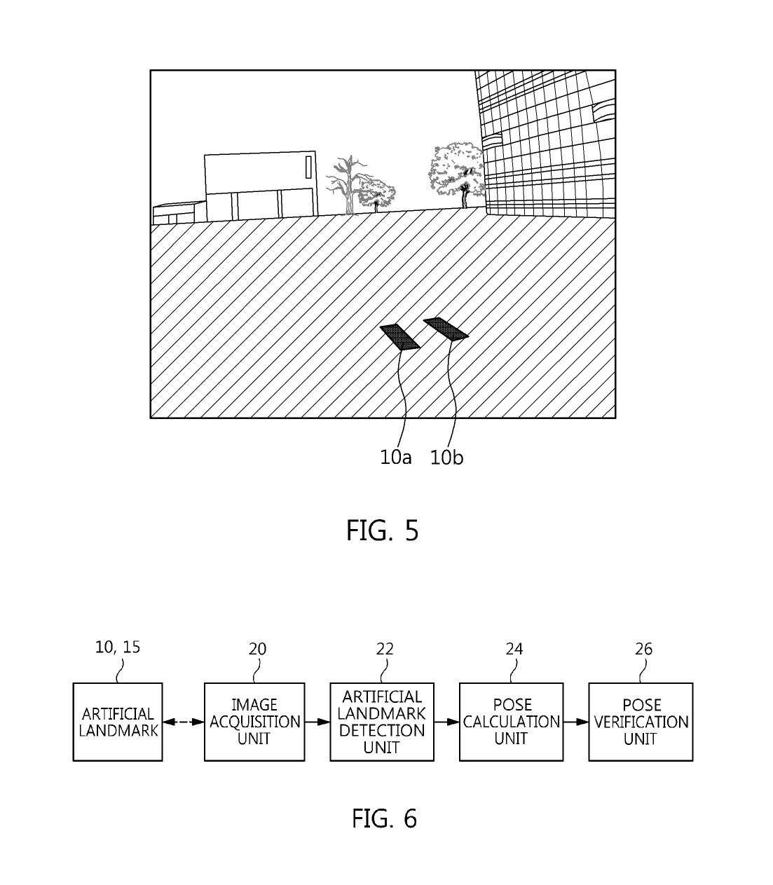

FIG. 5 is a diagram showing an example in which the artificial landmark employed in the embodiment of the present invention is attached to the surface of a road. The above-described artificial landmark 10 or 15 may be attached to (installed on) the surface of the road. In FIG. 5, a state in which the artificial landmark 10 is installed as an example on the ground of the road is illustrated.

The artificial landmark employed in the embodiment of the present invention has two predetermined types such as the artificial landmark 10 of FIG. 3 and the artificial landmark 15 of FIG. 4. It is possible, of course, that any one predetermined type of artificial landmark may be used alone or two predetermined types of artificial landmarks may be used in a combination form depending on the applications.

The predetermined type may include at least one of a first type and a second type. A mark of the first type may be a mark composed of a pair of bars, as shown B type in the FIG. 5. A mark of the second-type may be a [symbol] ”-shaped mark, as shown A type in the FIG. 5.

In particular, upon being applied to an outdoor road environment, the artificial landmark 10 or 15 is indicated using white or yellow color. It is more preferable to cause the thickness of lines constituting the artificial landmark 10 or 15 to be identical to that of lane-dividing lines (e.g., 15 cm) so that the artificial landmark is harmonious with a typical road environment. However, it is possible to implement various artificial landmarks having various sizes and colors depending on the applications.

Meanwhile, when the artificial landmark is attached to or printed on the surface of the road, the artificial landmark 10 has less visual resistance than that of the artificial landmark 15, and may be more naturally harmonious with the road environment.

However, since the artificial landmark 10 has a rotation ambiguity of 180° (images viewed from above and from below are identical), the artificial landmark 15 having no rotation ambiguity may be used in combination with the artificial landmark 10 if necessary. For example, the artificial landmark 15 may be used at a source, a destination, principle corners, etc., and the artificial landmark 10 may be used on linear driving roads.

FIG. 6 is a configuration diagram showing an apparatus for recognizing the location of an object according to an embodiment of the present invention.

The apparatus for recognizing the pose of an object according to the embodiment of the present invention includes an image acquisition unit 20, an artificial landmark detection unit 22, a pose calculation unit 24, and a pose verification unit 26.

The image acquisition unit 20 acquires an image of the artificial landmark 10 or 15. The image acquisition unit 20 includes an image acquisition device such as a camera. The image acquisition device is mounted on the object to acquire an image of the artificial landmark 10 or 15. The object may be a mobile object. Here, the image acquisition device may preferably be installed on an upper portion of the object if possible so as to secure a wide visual field.

The artificial landmark detection unit 22 processes the image acquired (captured) by the image acquisition unit 20 and determines and detects whether the artificial landmark 10 or 15 of a predetermined type is present in the image.

The pose calculation unit 24 extracts information about a geometric relationship between the artificial landmark 10 or 15 and the object from an image coordinate and a world coordinate of the artificial landmark 10 or 15, detected by the artificial landmark detection unit 22, and calculates the pose of the object based on the geometric relationship information. The image coordinate of an object in an image may be a coordinate of the object in the image.

The pose verification unit 26 finally determines (verifies) whether the pose of the object calculated by the pose calculation unit 24 are within an effective range.

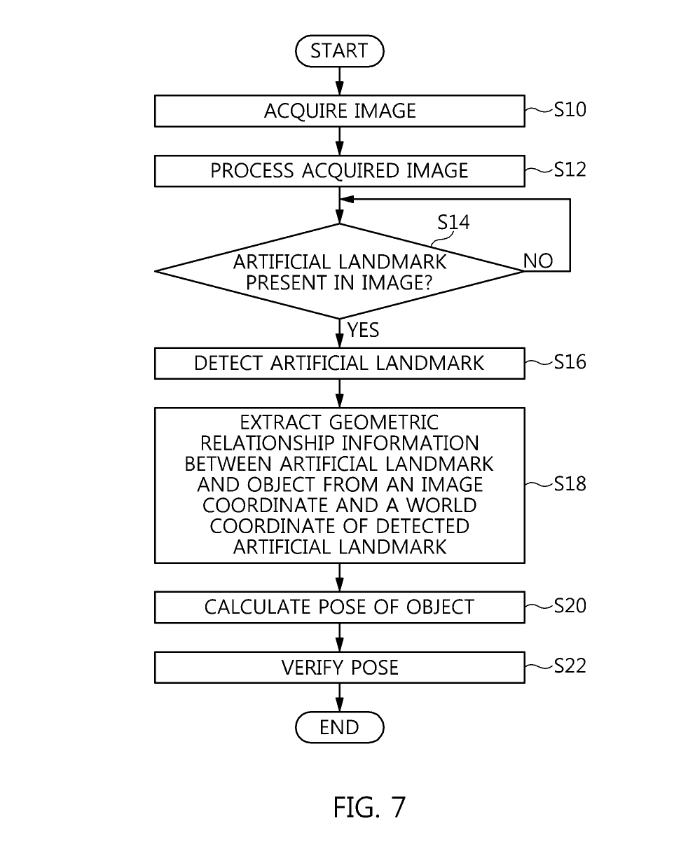

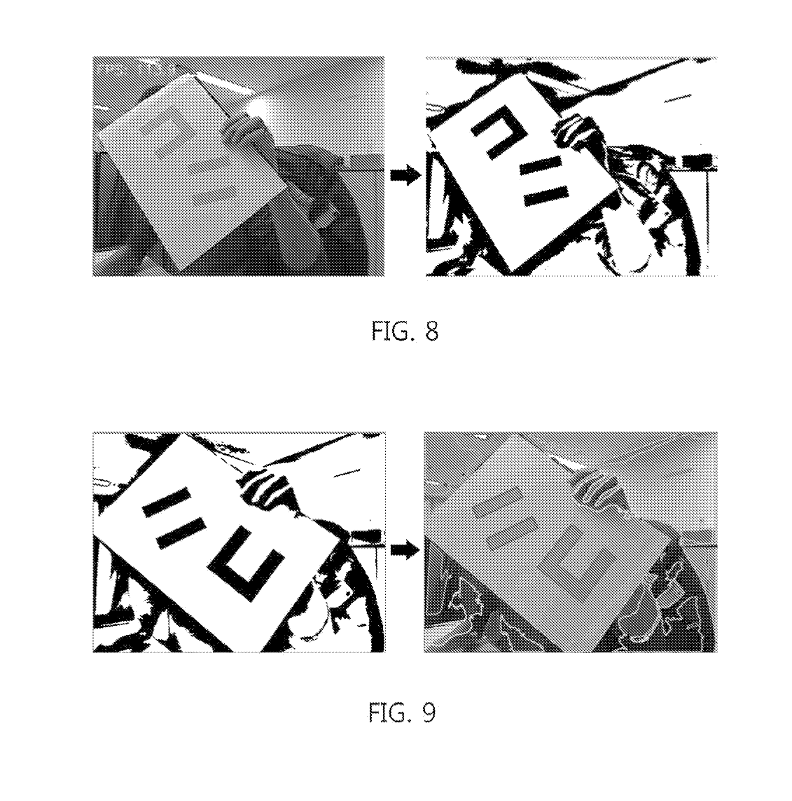

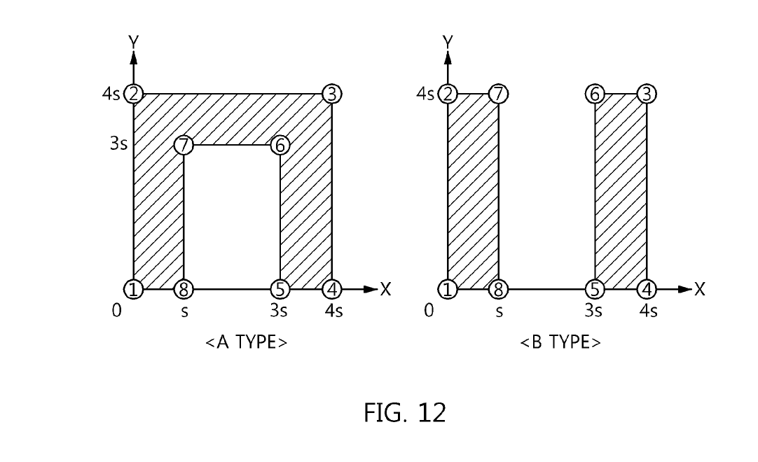

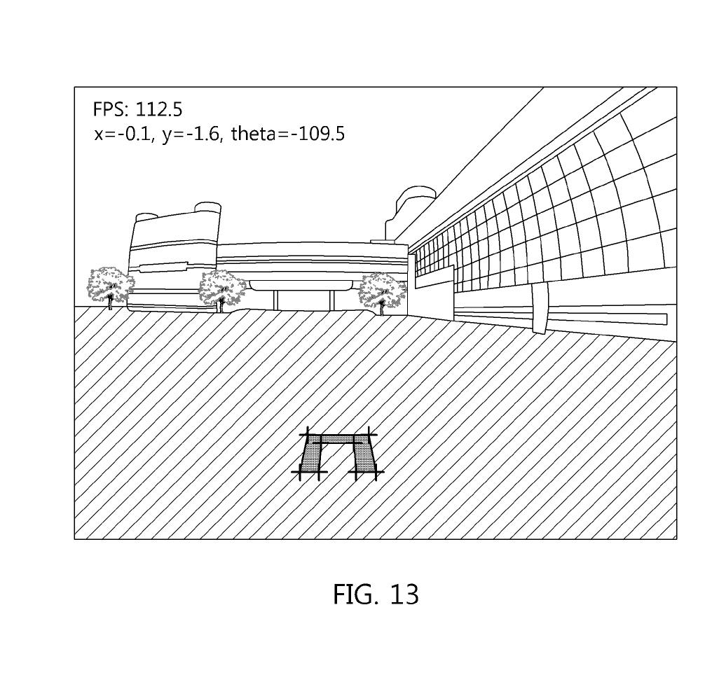

FIG. 7 is a flowchart showing a method for recognizing the pose of an object according to an embodiment of the present invention, FIGS. 8 to 11 are diagrams applied to the description of an artificial landmark detection step shown in FIG. 7, and FIGS. 12 and 13 are diagrams applied to the description of steps S18 and S20 shown in FIG. 7.

In order to recognize the pose of an object, it is assumed that at least one of the artificial landmark 10 and the artificial landmark 15 is installed on the surface of a road.

First, the image acquisition unit 20 acquires an image of an artificial landmark (at least one of the artificial landmark 10 and the artificial landmark 15) via an image acquisition device such as a camera mounted on the object at step S10.

Then, the artificial landmark detection unit 22 processes the image, acquired by the image acquisition unit 20, at step S12, and determines whether the artificial landmark 10 or 15 of the predetermined type is present in the processed image. If it is determined that the landmark is present (Yes at step S14), the artificial landmark detection unit 22 extracts the pose of the artificial landmark from the image at step S16. Here, the image processing method for detecting the artificial landmark 10 or 15 from the image may be implemented using various methods, and any of various methods may be used. For example, the artificial landmark 10 or 15 may be detected via a process for separating the artificial landmark 10 or 15 from background using a procedure of binarizing image brightness values of an input image, a process for extracting candidate landmarks via the analysis of connected components, and a process for determining whether the detected artificial landmark is an actual artificial landmark 10 or 15 by performing size inspection, shape inspection, or the like on the extracted candidate landmarks.

A method of detecting the artificial landmark 10 or 15 from the image will be described below with reference to the attached drawing. First, the artificial landmark detection unit 22 binarizes an input image on the left side of FIG. 8 and then forms an image state such as that illustrated on the right side of FIG. 8. Image binarization denotes a procedure of, depending on whether the brightness value of each pixel constituting an image is less than or greater than a preset threshold value, classifying the pixel of the image as one of black (that is, when the brightness value of the pixel is less than the threshold value, wherein it may be considered that the pixel is darker than the threshold value) and white (that is, when the brightness value of the pixel is greater than the threshold value, wherein it may be considered that the pixel is brighter than the threshold value).

Next, connected components are found from the binarized image via a connected component analysis procedure, and contours of the found components are extracted. FIG. 9 illustrates an example of contour extraction.

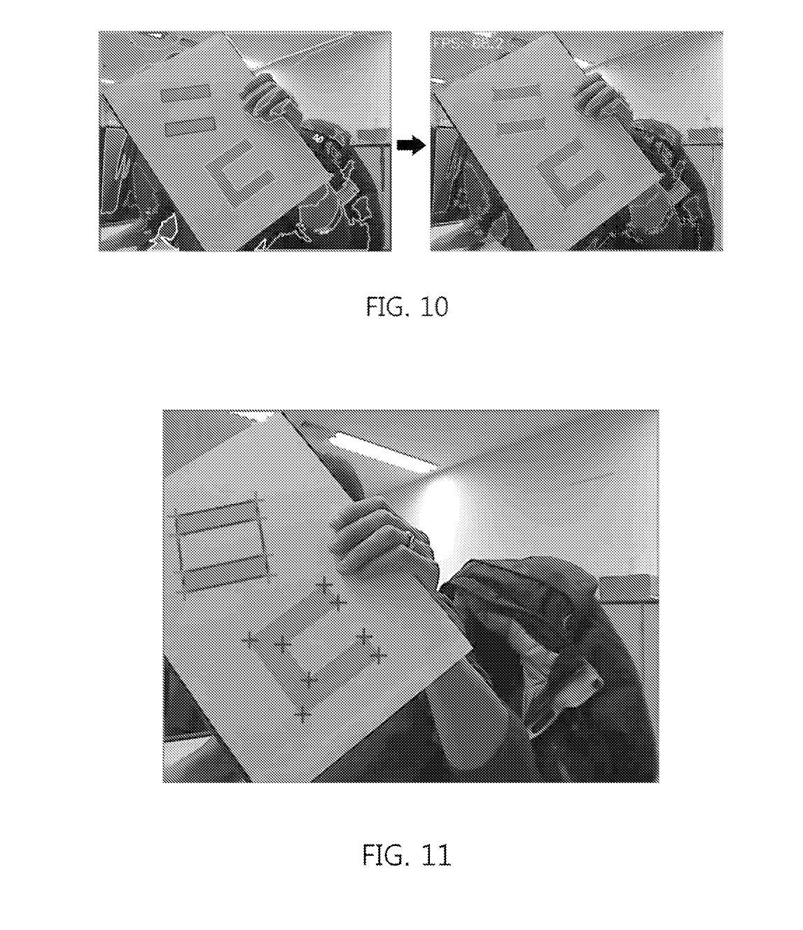

Thereafter, the extracted contours of the connected components are approximated to polygons. FIG. 10 illustrates an example of polygon approximation.

After the contours of the detected connected components have been approximated to polygons in this way, the approximated polygons are analyzed, and then it is determined whether the detected connected components correspond to an artificial landmark. Here, various condition inspections may be performed. A condition that may be most easily considered is to use the number of vertexes of approximated polygons, as illustrated in FIG. 12. That is, in the case of an A-type mark (artificial landmark 15), there are eight vertexes, and thus approximated polygons that are octagons are extracted as mark candidates. In the case of a B-type mark (artificial landmark 10), approximated polygons that are quadrangles are extracted as mark candidates. However, in practice, an error may occur in a polygon approximation procedure, and thus it is preferable to extract polygons ranging from a heptagon to a nonagon as candidates in the case of the A-type mark (artificial landmark 15), and extract polygons ranging from a triangle to a pentagon as candidates in the case of the B-type mark (artificial landmark 10), in consideration of the occurrence of an error. Further, whether the shapes of the approximated polygons are similar to that of the artificial landmark may be a powerful condition. One method of determining whether the shapes of approximated polygons are similar to that of the artificial landmark via a comparison is to obtain a minimum bounding box enclosing an approximated polygon, and calculate a transformation matrix H required to transform the minimum bounding box into a square (rectangle) that is the shape of a mark. In the case of A-type mark candidates, such a transformation matrix H may be calculated for each candidate polygon. In contrast, in the case of B-type mark candidates, two bar-type marks are paired to form a landmark, and thus a transformation matrix H is calculated for a minimum bounding box enclosing two candidate polygons (quadrangles). For reference, such a transformation matrix H may be easily calculated using image homography. Then, individual vertexes constituting each approximated polygon are transformed using the transformation matrix H. Thereafter, by using how the transformed coordinates match those of vertexes constituting an actual artificial landmark, it is determined whether the shape of the approximate polygon is similar to that of the artificial landmark. FIG. 11 illustrates only candidate polygons passing the inspections of both the condition of the number of vertexes and the condition of a shape among approximated polygons.

When this procedure is performed, the artificial landmark 10 or 15 may be detected from the image.

Next, the pose calculation unit 24 extracts information about a geometric relationship between the artificial landmark 10 or 15 and the object from the image coordinate and the world coordinate of the artificial landmark 10 or 15 detected by the artificial landmark detection unit 22 at step S18, and calculates the pose of the object at step S20.

One of the facts well known in the field of image processing is that, if image coordinates of four different points of a planar object (provided that any three points should not be collinear) are known, a relative three-dimensional (3D) location relationship between the object and a camera may be detected from the image coordinates. A great variety of calculation algorithms related to this are present, and any of the algorithms may be used. For example, a method or code disclosed in the following papers may be utilized.

1) Reference paper 1: X. S. Gao, X.-R. Hou, J. Tang, H.-F. Chang “Complete Solution Classification for the Perspective-Three-Point Problem”, PAMI 2003

2) Reference paper 2: V. Lepetit, F. Moreno-Noguer and P. Fua. EPnP: An Accurate O(n) Solution to the PnP Problem, in International Journal Of Computer Vision, vol. 81, p. 155-166, 2009

3) Algorithm source code: http:// cvlab.epfl.ch/software/EPnP

The relative location of the camera to the artificial landmark 10 or 15 may be calculated using any four different points on the artificial landmark 10 or 15, based on the above-described method. Preferably, four vertexes of a minimum bounding box enclosing the artificial landmark 10 or 15 may be used.

A pose calculation procedure performed by the pose calculation unit 24 will be described below using an example shown in the drawing. It is assumed that the absolute location of an attached mark (location in a world coordinate system) is previously given.

As illustrated in FIG. 12, for both A type and B type, a single mark is composed of eight vertexes. If pixel coordinates of the image corresponding to the absolute coordinates (world coordinates) of any four of these eight vertexes are known, the 3D location and pose (x, y, z, pitch, roll, and yaw) of the camera that acquires the image may be detected by applying the above-described method (reference paper 1, reference paper 2, and Efficient Perspective N-Point (EPnP) algorithm) to the image. These four vertexes may be freely set, but, in order to improve the precision of calculated locations, it is more preferable to use the four outermost vertexes of the mark (\textcircled{1}, \textcircled{2}, \textcircled{3}, and \textcircled{4} in FIG. 12). That is, absolute world coordinates of the four vertexes \textcircled{1}, \textcircled{2}, \textcircled{3}, and \textcircled{4} that is, (gx1, gy1), (gx2, gy2), (gx3, gy3), and (gx4, gy4) are previously given. If image pixel coordinates of the image corresponding to the four vertexes are known, the 3D pose information of the camera is calculated. In this case, for the A-type mark, the location of the camera may be uniquely determined using the above method, but for the B-type mark, there is a rotation ambiguity of 180° (images viewed from above and from below are identical), and thus two different camera locations are calculated. Therefore, in order to determine which one of two camera locations calculated for the B-type mark corresponds to an actual camera location, additional information is required. For example, the most recent location of the camera or location information received from an auxiliary location recognition means, such as a GPS, may be used as the additional location information. FIG. 13 illustrates an example of the result of calculating the pose of a vehicle in such a way as to attach an actual artificial landmark to the surface of a road and recognize the artificial landmark using a camera mounted on the vehicle. For reference, the calculated pose of the camera may be set to the pose of the object. However, when the location of the camera is not the reference position of the object, the offset of the pose of the camera calculated via the above-described procedure (offset: the relative location of the mounted camera to the reference point of the location of the object) is compensated for, thus enabling the pose of the object to be calculated.

In this way, the location of the object may be calculated by the pose calculation unit 24.

After the calculation of the location, the pose verification unit 26 finally determines (verifies) whether the pose of the object calculated by the pose calculation unit 24 are within an effective range at step S22. That is, at the location verification step S22, whether the pose of the object calculated at the location calculation step are within the effective range is finally determined. If it is determined that the pose are not effective values, the landmark detected from the image is regarded as being caused by false detection (misdetection), so that the calculated location value is ignored. Only if it is determined that the pose are within the effective range, the location information is utilized as a normal location result value.

The reason for needing the location verification step S22 is that, when natural geographic features or patterns having shapes similar to artificial landmarks are present in an actual natural environment, there may occur a case where it is difficult to determine whether a detected object is an artificial landmark using only image processing.

At the above-described location verification step S22 (this may be regarded as an artificial landmark verification step), the location calculated due to false detection is eliminated based on whether the 3D location information of the camera calculated at the location calculation step falls within an error range from the actual location of the camera. For example, in a case where a camera is installed on a vehicle or the like, it is assumed that the camera is mounted to have a height of 1.5 m from the ground surface and to perpendicularly face the front (the ground surface and the optical axis of the camera are horizontal to each other). In this case, when the location of the camera calculated via image recognition indicates a height of 5 m from the ground surface, and the calculated direction of the camera indicates −80° (e.g., this location value may appear when the pattern of the wall surface of a building is recognized as a landmark), the calculated pose cannot be regarded as being obtained from the detection of a normal artificial landmark and thus deserves to be eliminated as the result of misdetection. Preferably, the error range of the location of the normal camera may be suitably designated through experiments according to an application environment.

When the location verification step S22 is applied, the locations of figures only having a shape and size similar to those of an artificial landmark while being present on the ground are calculated as those of mark candidates, so that it may be considered that a case rarely occurs where objects that are not artificial landmarks are misdetected and the locations of the objects are calculated. Therefore, the reliability of the location recognition system according to the present invention may be regarded as very high.

Meanwhile, since a range that can be covered by a single artificial landmark 10 or 15 in the present invention is limited, a plurality of artificial landmarks 10 or 15 must be installed when an object needs to be operated in a wide space other than a narrow space.

However, the artificial landmark 10 or 15 of the present invention merely has A-type (artificial landmark 15) and B-type (artificial landmark 10) divisions, but does not include ID information in the landmark, and thus there is a possibility that the problem of identification between artificial landmarks may occur. Therefore, when two or more artificial landmarks 10 or 15 are installed, the artificial landmarks are preferably used in combination with a separate location recognition means such as a GPS or wheel odometry. In this case, location recognition via the artificial landmarks 10 or 15 is used in such a way as to correct the location error of an inaccurate position sensor (GPS or wheel odometry). In this way, when a plurality of artificial landmarks are used in combination with a separate location recognition sensor, it is preferable to set the landmark installation interval to a value above the maximum location error value of the separate position recognition sensor and to install landmarks so that identification between landmarks is possible.

In accordance with the present invention having the above configuration, the location of an object may be recognized in indoor and outdoor environments by merely attaching a simple landmark, thus enabling applications such as various unmanned vehicles, factory automation systems, unmanned shuttle robots, and autonomous driving service robots based on such location recognition to be implemented.

Further, since artificial landmarks in the present invention have shapes similar to those of existing road marks (stop lines, arrows, lane dividing lines, etc.) present in a road environment, the artificial landmarks are inconspicuous and have less visual resistance, and thus they are expected to be more widely utilized.

Furthermore, since the artificial landmarks in the present invention have excellent identifiability and are easily detectable thanks to the simple structures thereof, the artificial landmarks may be detected even at a long distance and may enable more stable location recognition.

Furthermore, in accordance with the present invention, there is an advantage in that the problem of conventional artificial landmarks having low utilization from the standpoint of a design in spite of the high practicality thereof may be solved, thus enabling the artificial landmarks of the present invention to be more easily used in actual applications.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for recognizing a location of an object, comprising:
an image acquisition unit for acquiring an image;
an artificial landmark detection unit for processing the image acquired by the image acquisition unit and detecting an artificial landmark of a predetermined type from the image;
a pose calculation unit for calculating a pose of the object based on an image coordinate and a world coordinate of the artificial landmark detected by the artificial landmark detection unit; and
a pose verification unit for verifying whether the pose of the object calculated by the pose calculation unit are within an effective range.

2. The apparatus of claim 1, wherein the artificial landmark detection unit binarizes the input image acquired by the image acquisition unit, analyzes connected components of a binarized image, extracts contours of the connected components, approximates the extracted contours of the connected components to polygons, analyzes the approximated polygons, and determines whether the connected components correspond to the artificial landmark.

3. The apparatus of claim 2, wherein the artificial landmark detection unit analyzes the approximated polygons based on a number of vertexes of the approximated polygons and shapes of the approximated polygons, and then determines whether the connected components correspond to the artificial landmark.

4. The apparatus of claim 1, wherein the pose calculation unit extracts information about a geometric relationship between the artificial landmark and the object from the image coordinate and the world coordinate of the artificial landmark detected by the artificial landmark detection unit, and calculates the pose of the object based on the extracted geometric relationship information.

5. The apparatus of claim 1, wherein the pose verification unit ignores values of the pose of the object calculated by the pose calculation unit if it is determined that the calculated pose of the object are not effective values.

6. The apparatus of claim 1, wherein the artificial landmark is installed on a surface of a road.

7. The apparatus of claim 1, wherein the predetermined type includes a first-type, and a mark of the first-type is a mark composed of a pair of bars.

8. The apparatus of claim 7, wherein the mark composed of a pair of bars is installed on a surface of a linear driving road.

9. The apparatus of claim 1, wherein the predetermined type mark includes a second-type, and a mark of the second-type is a “ [symbol] ”-shaped mark.

10. The apparatus of claim 9, wherein the “ [symbol] ”-shaped mark is installed on a surface of a road at each of a source, a destination, and principal corners.

11. A method for recognizing a location of an object, comprising:
acquiring, by an image acquisition unit, an image;
detecting, by an artificial landmark detection unit, an artificial landmark of a predetermined type from the acquired image by processing the acquired image;
calculating, by a pose calculation unit, a pose of the object based on an image coordinate and a world coordinate of the detected artificial landmark; and
verifying, by a pose verification unit, whether the calculated pose of the object are within an effective range.

12. The method of claim 11, wherein detecting the artificial landmark comprises:
binarizing the acquired input image;
analyzing connected components of a binarized image, and extracting contours of the connected components;
approximating the extracted contours of the connected components to polygons; and
analyzing the approximated polygons, and determining whether the connected components correspond to the artificial landmark.

13. The method of claim 12, wherein determining whether the connected components correspond to the artificial landmark comprises analyzing the approximated polygons based on a number of vertexes of the approximated polygons and shapes of the approximated polygons, and then determining whether the connected components correspond to the artificial landmark.

14. The method of claim 11, wherein calculating the pose of the object comprises:
extracting information about a geometric relationship between the artificial landmark and the object from an image coordinate and a world coordinate of the detected artificial landmark; and
calculating the pose of the object based on the extracted geometric relationship information.

15. The method of claim 11, wherein verifying whether the pose are within an effective range comprises ignoring values of the calculated pose of the object if it is determined that the calculated pose of the object are not effective values.

16. The method of claim 11, wherein the artificial landmark is installed on a surface of a road.

17. The method of claim 11, wherein the predetermined type includes a first-type, and a mark of the first-type is a mark composed of a pair of bars.

18. The method of claim 17, wherein the mark composed of a pair of bars is installed on a surface of a linear driving road.

19. The method of claim 11, wherein the predetermined type includes a second-type, and a mark of the second-type is a “ [symbol] ”-shaped mark.

20. The method of claim 19, wherein the “ [symbol] ”-shaped mark is installed on a surface of a road at each of a source, a destination, and principal corners.
